(19) United States
(12) Patent Application Publication
(10) Pub. No.: US 2024/0051786 A1
(43) Pub. Date: Feb. 15, 2024

(54) CORD TANGLE PREVENTION DEVICE

(71) Applicant: Cordi, LLC, Sebastopol, CA (US)

(72) Inventors: Sarah Renae Suchla, Santa Rosa, CA (US); David Cherry, Bozeman, MT (US)

(21) Appl. No.: 17/885,793

(22) Filed: Aug. 11, 2022

(51) Int. Cl. B65H 75/34

(52) U.S. Cl. CPC B65H 75/34

(57) ABSTRACT

A cord tangle prevention device is provided, the device having an elongated body having a top surface and a bottom surface. The elongated body constructed of a single piece of flexible material having a first end and a second end forming a shape, such as a spiral or cylinder, having a central channel extending from the top surface to the bottom surface, and an entry channel leading into the central channel. The central channel configured to secure and clamp an electrical cord within the elongated body such that the electrical cord does not tangle during use.

### CROSS-REFERENCE TO RELATED APPLICATIONS

N/A

### BACKGROUND OF THE INVENTION

### 1. Field of the Invention

The present invention relates generally to cord management but more particularly to a cord tangle prevention device.

### 2. Description of Related Art

Equipment under constant motion that requires electrical cords are subject to tangling, such as power tools, hairdressing tools, and other specialties. For example, during hairdressing, hairdressers often struggle with keeping electrical cords for their devices organized and untangled. As well known in the art, hairdressers are often circling their client who is usually seated in a barber's or salon chair. Often the electrical cords for hairdryers, straighteners, razors, and other devices get tangled during use. There are products designed to manage cords, but they are designed for static cords and do not perform particularly well with dynamic cords that are constantly in motion, such as during hairdressing. Consequently, a solution is needed.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present invention to provide a cord tangle prevention device configured to be placed in series on an electrical cord to prevent the cord from tangling. It is yet another object of the present invention to be able to secure the cord tangle prevention device on the cord such that the device stays in place during use.

In order to do so, a cord tangle prevention device is provided, comprising a body having a top surface and a bottom surface, wherein the body is constructed of a single piece of material having a first end and a second end; the first end and the second end forming an entry channel extending from the top surface to the bottom surface, wherein the entry channel leads into a central channel within the body; and, the central channel configured to secure an electrical cord within the body of the cord tangle prevention device.

In one embodiment, the single piece of material is a flexible material. In another embodiment, the flexible material enables a user to expand the entry channel allowing the user to securely position the electrical cord within the central channel. In one embodiment, the entry channel extends vertically from the top surface to the bottom surface. In one embodiment, the first end and the second end form a spiral, such that the entry channel spirals into the central channel. In one embodiment, the electrical cord is configured to be clamped within the central channel. In one embodiment, a number of cord tangle prevention devices are configured to be secured along the electrical cord to prevent the electrical cord from tangling. In another embodiment, the body is approximately six inches in length. In one embodiment, the flexible material is thermoplastic polyurethane (TPU). In one embodiment, the central channel includes a plurality of channels, wherein each channel of the plurality of channels has a different diameter or width. In yet another embodiment, at least one barb is positioned between the channels of the plurality of channels, the at least one barb configured to clamp and secure the electrical cord with the central channel. In one embodiment, the entry channel spirals from the top surface to the bottom surface.

In another aspect of the invention, a cord tangle prevention device is provided, comprising an elongated body having a top surface and a bottom surface, wherein the elongated body is constructed of a single piece of flexible material having a first end and a second end, forming a spiral having a central channel and an entry channel spiraling into the central channel; the second end approximate to the central channel, and the fist end approximate to entry channel forming a tail of the spiral; and, the central channel configured to secure and clamp an electrical cord within the elongated body such that the electrical cord does not tangle during use. In one embodiment, the spiral forms between one and two rotations from the top surface to the bottom surface.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a cord tangle prevention device according to an embodiment of the present invention.

FIG. 2 is a top view of the cord tangle prevention device according to an embodiment of the present invention.

FIG. 3 is a detailed view of the cord tangle prevention device in use according to an embodiment of the present invention.

FIG. 4 is a perspective view of several cord tangle prevention devices in use according to an embodiment of the present invention.

FIG. 5 is a perspective view of a first alternative cord tangle prevention device according to an embodiment of the present invention.

FIG. 6 is a top view of the first alternative cord tangle prevention device according to an embodiment of the present invention.

FIG. 7 is a perspective view of a second alternative cord tangle prevention device according to an embodiment of the present invention.

FIG. 8 is a top view of the second alternative cord tangle prevention device according to an embodiment of the present invention.

FIG. 9 is a perspective view of a third alternative cord tangle prevention device according to an embodiment of the present invention.

FIG. 10 is a top view of the third alternative cord tangle prevention device according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a cord tangle prevention device.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about,” “generally,” or “approximately,” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

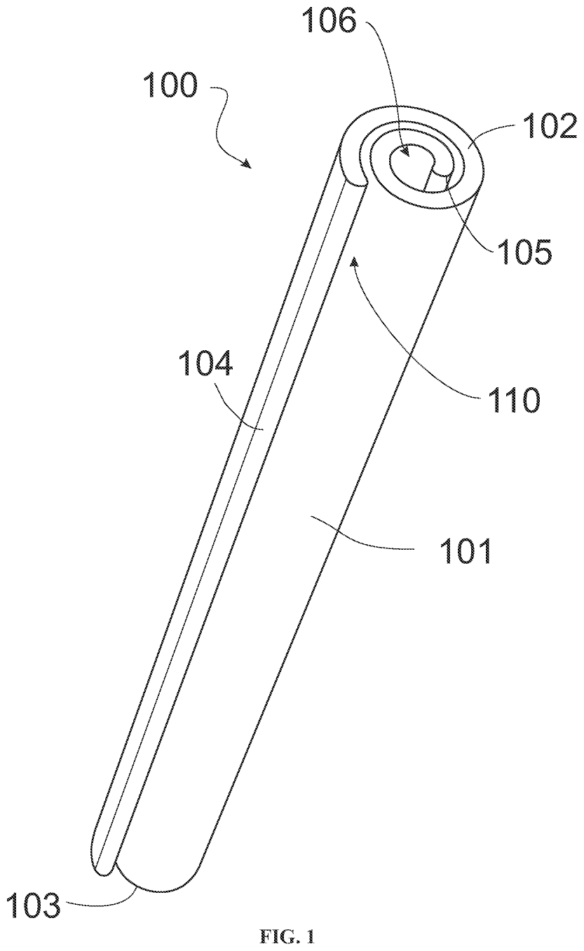

FIG. 1 is a perspective view of a cord tangle prevention device according to an embodiment of the present invention. Referring now to FIG. 1, the cord tangle prevention device 100 is illustrated. In one embodiment, the cord tangle prevention device 100 comprises a body 101 having a top surface 102 and bottom surface 103. In one embodiment, the body 101 is constructed with a single piece of material having a first end 104 and a second end 105. In a preferred embodiment, body 101 is comprised of a flexible material. In one embodiment, the flexible material is rubber, or a rubber like material, or an elastomer comprised of plastic, silicone, or similar. In some embodiments, the flexible material is thermoplastic polyurethane (TPU). Ideally, the material can be 3D printed. However, it should be understood that other production methods are possible as well known in the art. Though, the flexibility of the material is critical to the design and use of the device, which will be described in further details below.

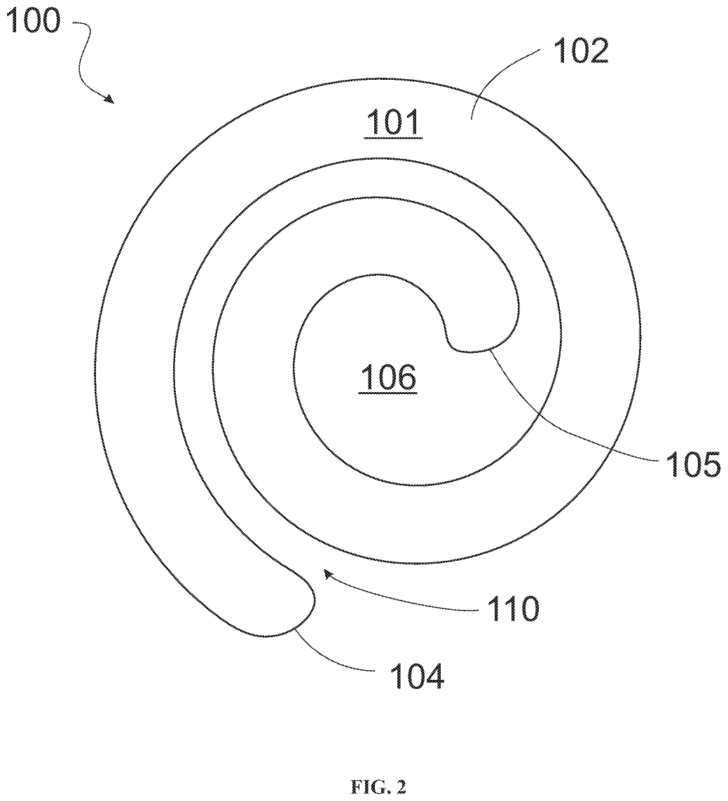

Referring now to FIGS. 1-2, the body is comprised of a spiral shape, with the first end 104 and the second end 105 forming the spiral creating a central channel 106 and entry channel 110. The second end 105 positioned on the inside near the center, and the fist end 104 positioned on the outside forming the tail of the spiral. During use, an electrical cord is configured to be positioned within the central channel 106 of the cord tangle prevention device 100. In order to do so, the flexible material of the body 101 is configured to stretch such that the entry channel 110 may expand in width allowing a user to feed the electrical cord through the entry channel 110, around the spiral shape and into the central channel 106. The spiral shape body, edges, and ends should be free of sharp areas that could damage the electrical cord or injure the user operating the device 100. In this embodiment, the cord tangle prevention device 100 has an identical top surface 102 and bottom surface 103 shape, i.e. the spiral shape is consistent through the entire length of the device 100.

Advantageously, the spiral shape or swirl provides the user an easy way to put the electrical cord within the central channel 106, yet provides a secure lock, as it is very unlikely for the electrical cord to escape the central channel 106 during use, as the entry channel 110 around the spiral is configured to be smaller in width than the width or diameter of the electrical cord. Further, in some embodiments, the diameter or width of the central channel 106 is smaller than the width or diameter of the electrical cord such that the electrical cord is clamped into the central channel 106.

In one embodiment, the length (from the top surface 102 to the bottom surface 103) is approximately six inches long. In one embodiment, the spiral forms approximately 1.7 revolutions providing a 16 mm inner diameter of the central channel 106 and a 19 mm outer diameter or approximately ¾ inches.

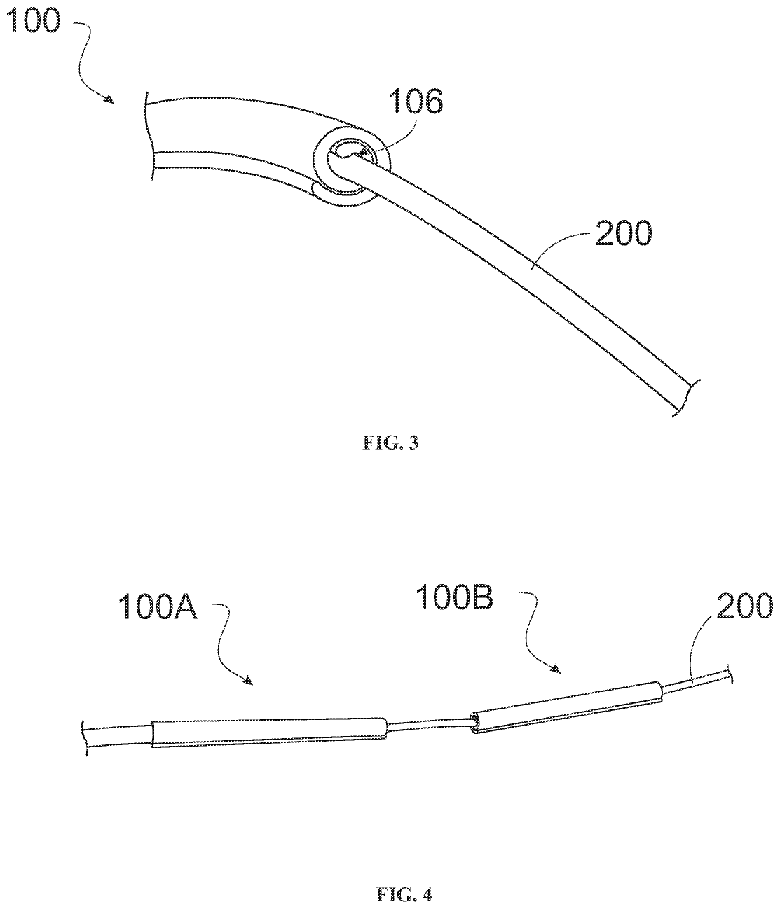

FIGS. 3-4 show the cord tangle prevention device 100 in use. More specifically, an electrical cord 200 is shown positioned within and clamped within the central channel 106 of the cord tangle prevention device 100. In one embodiment, multiple cord tangle prevention devices 100A, 100B, etc. are configured to be positioned on the electrical cord 200 for the length of the electrical cord. In one embodiment, it is recommended to position a device approximately every 6 inches with a 1 inch gap between devices. This arrangement provides sufficient electrical cord tangle prevention even during heavy use, rotation, and twisting of the electrical cord 200.

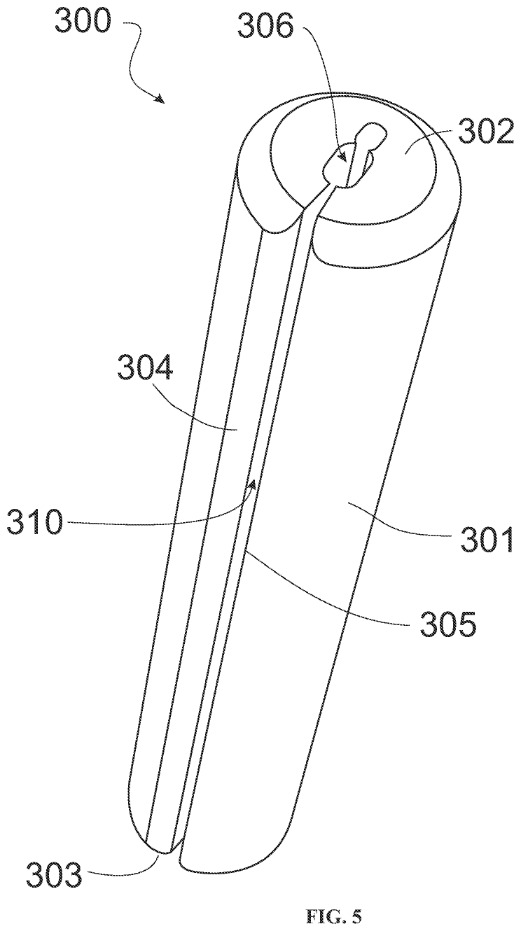

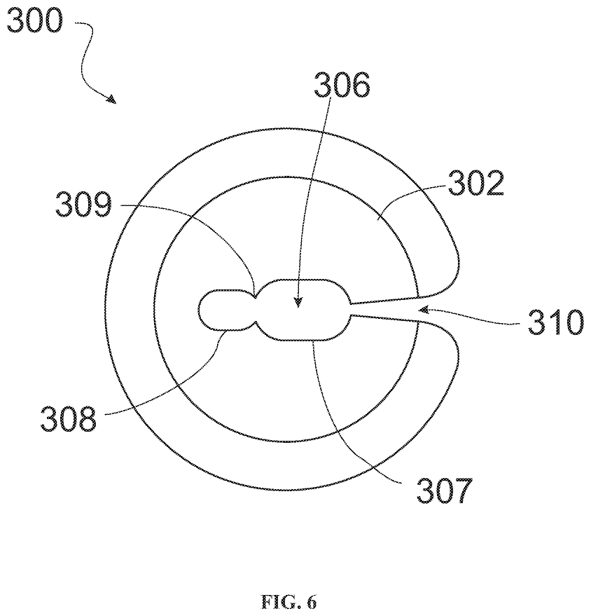

FIGS. 5-6 show a perspective view and top view respectively of a first alternative cord tangle prevention device 300 according to an embodiment of the present invention. Referring now to FIGS. 5-6, the first alternative cord tangle prevention device 300 is illustrated. In one embodiment, the first alternative cord tangle prevention device 300 comprises a body 301 having a top surface 302 and bottom surface 303. In one embodiment, the body 301 is constructed with a single piece of material having a first end 304 and a second end 305. Similarly to the first embodiment, the body 301 is comprised of a flexible material. In one embodiment, the flexible material is thermoplastic polyurethane (TPU) however the material may vary as previously discussed.

As seen in FIGS. 5-6, the body 301 is comprised of a cylindrical shape, with the first end 304 and the second end 305 forming an entry channel 310, wherein the entry channel 310 leads into a central channel 306. In one embodiment, the central channel 306 comprises a first channel 307 and a second channel 308, wherein the first channel is larger in diameter or width than the second channel. Similarly to the first embodiment, during use, an electrical cord is configured to be positioned within the central channel 306 of the first alternative cord tangle prevention device 300. In order to do so, the flexible material of the body 301 is configured to open, such that the first end 304 and the second end 305 are spread apart, opening or expanding the size of the entry channel 310 allowing a user to feed the electrical cord through entry channel 310, into the central channel 306. In some embodiments, the electrical cord is configured to be clamped primarily in the first channel 307. In some embodiments, a portion of the electrical cord may be clamped in the second channel 308. As well known in the art, electrical cords or cables may be provided in different shapes, including but not limited to, cylindrical, oval, braided, cylindrical—with squared edges, two separate cords connected or bonded together, etc. Advantageously, where the first channel 307 and the second channel 308 meet is a pair of barbs 309, configured to aid in the clamping of the electrical cord, regardless of the type or shape the electrical cord is comprised of. The barbs are not sharp enough to damage the electrical cord's protective covering.

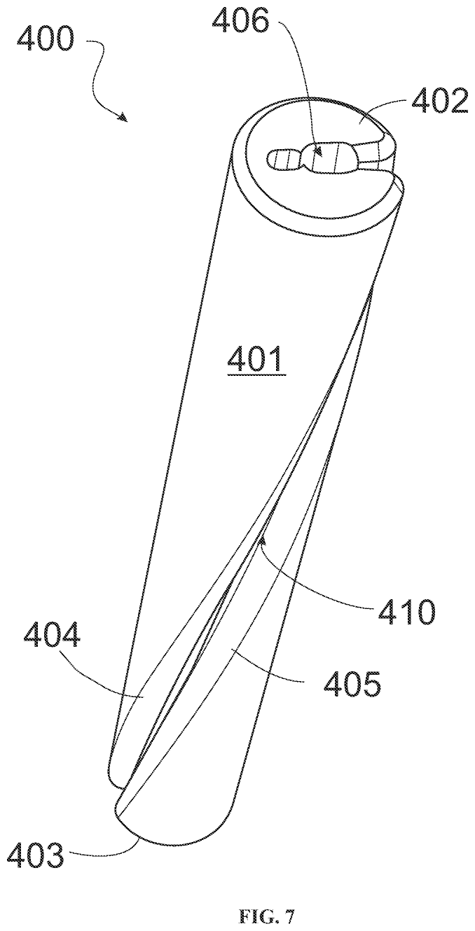

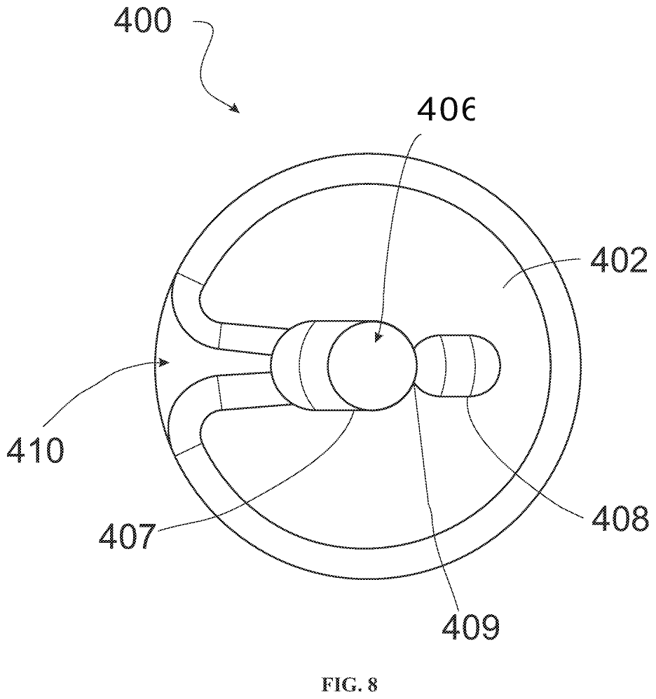

FIGS. 7-8 show a perspective view and top view respectively of a second alternative cord tangle prevention device 400 according to an embodiment of the present invention. Referring now to FIGS. 7-8, the second alternative cord tangle prevention device 400 is illustrated. In one embodiment, the second alternative cord tangle prevention device 400 comprises a body 401 having a top surface 402 and bottom surface 403. In one embodiment, the body 401 is constructed with a single piece of material having a first end 404 and a second end 405, wherein the first end 404 and the second end 405 spiral around the cylindrical body 401. This will be discussed in further details below.

In one embodiment, the cylindrical body 401 is comprised of a flexible material with the first end 404 and the second end 405 forming an entry channel 410 spiraling around the cylindrical body. As with the previous embodiments, the entry channel 410 leads into a central channel 406. In one embodiment, the central channel 406 comprises a first channel 407 and a second channel 408, wherein the first channel is larger in diameter or width than the second channel. During use, an electrical cord is configured to be positioned within the central channel 406 of the second alternative cord tangle prevention device 400. As opposed to the first alternative cord tangle prevention device 300 (FIGS. 5-6), where the body is configured to open or split apart, enabling the position of the electrical cord with the central channel, in this embodiment, the user may screw in the electrical cord by placing the cord within the entry channel 410 then rotating the cylindrical body 401 feeding the electrical cord to the central channel 406. The flexibility of the material enables the spreading of the first end 404 and the second end 405 as needed to increase the width of the channels. The shape and structure of the top surface 402 and bottom surface 403 of the second alternative cord tangle prevention device 400 are identical to the shape and structure of the top surface 302 and bottom surface 303 of first alternative cord tangle prevention device 300, yet the bottom surface 403 is orientated approximately 180 degrees forming the spiral shape of the entry channel 410. Thus, in this embodiment, the electrical cord is similarly configured to be clamped within the first 407 and second chancels 408 of the central channel 406, as well as between the barbs 409 for added clamping pressure. Advantageously, the spiral shape is configured to aid in keeping the electrical cord secure within the device 400 during use. In one embodiment, the first end 304 and the second end 305 spiral approximately 12 rotation forming the 180 degree difference of orientation between the top surface 402 and the bottom surface 403 as previously discussed.

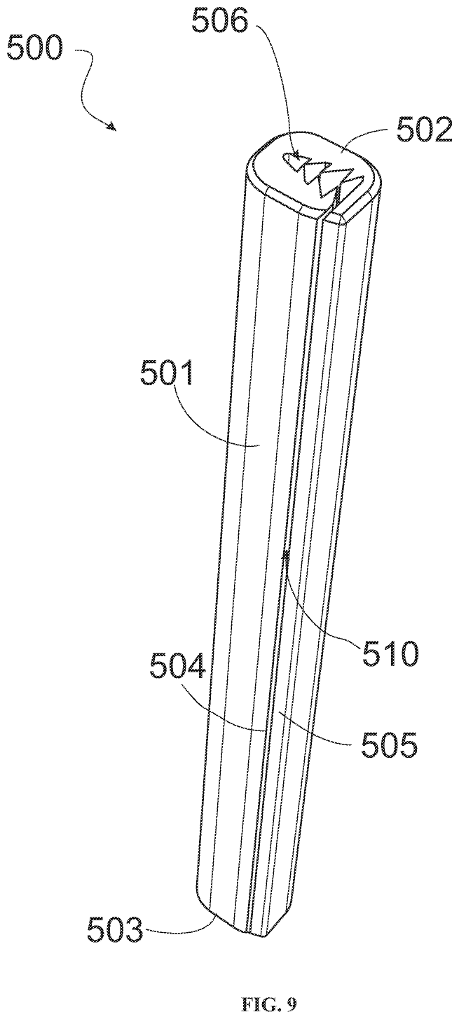

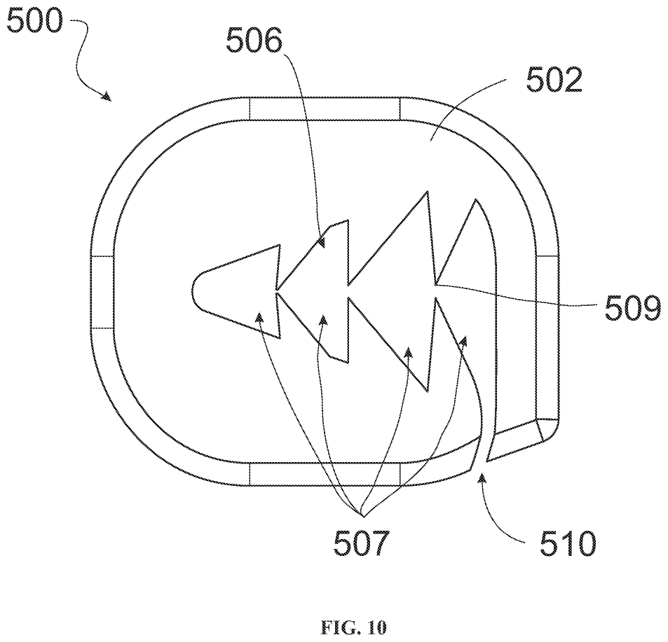

FIGS. 9-10 show a perspective view and top view respectively of a third alternative cord tangle prevention device 500 according to an embodiment of the present invention. Referring now to FIGS. 9-10, the third alternative cord tangle prevention device 500 is illustrated. In one embodiment, the third alternative cord tangle prevention device 500 comprises a body 501 having a top surface 502 and bottom surface 503. In one embodiment, the body 501 is constructed with a single piece of material having a first end 504 and a second end 505.

In one embodiment, body 501 is constructed of a rounded square, truncated circle, or squircle. Similarly to the other embodiments, the body 501 is comprised of a flexible material with the first end 504 and the second end 505 forming an entry channel 510, the entry channel extending throughout the body 501 lengthwise, wherein the entry channel 510 leads into a central channel 506. In one embodiment, the central channel 506 comprises a plurality of channels 507. In one embodiment, the plurality of channels is four channels in descending size resembling a Christmas tree. Between each channel of the plurality of channels is a pair of barbs 509 configured to catch or retain the electrical cord as previously discussed. During use, an electrical cord is configured to be positioned within the central channel 506 of the third alternative cord tangle prevention device 500 by opening or spreading the first end 504 and the second end 505 away from each other, increasing the size of the central channel 509 and individual channels of the plurality of channels 507 with the body 501. Once the flexible body 501 is returned to its original shape (as illustrated), the plurality of channels 507 are configured to securely retain the electrical cord with the central channel 506 of the device 510.

Advantageously, all the various designs of the present invention are configured to securely retain an electrical cord, particularly an electrical cord used by a hairdresser or other activity under motion, power tools, etc., such that the electrical cord does not tangle during the twisting, rotation, pulling, and similar motions during use. Further, although each design has different structures, they function similarly and have the same inventive features, including but not limited to central channels positioned with an elongated flexible body configured to retain an electrical cord as well as entry channels configured to lead to the central channel, the design of the entry channel and central channel combination enabling a locking type property to securely hold the electrical cord during use.

Although indented for hairdresser or power tool cord tangle prevention, the device may be used on any electrical cords in different fields. The device may be comprised of a variety of colors or other ornamental characteristics. Instructions and text may be provided on the outer surface of the body to instruct users how to operate the device, including how to secure the electrical cord and how many devices to use per electrical cord, i.e. the spacing of the device throughout the electrical cord. The device may be solid, opaque, or transparent. The device is free from secondary fasteners, such as hook and look fasteners (Velcro®), zippers, buttons, latches, twist-ties, etc.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A cord tangle prevention device comprising:
a body having a top surface and a bottom surface, wherein the body is constructed of a single piece of material having a first end and a second end;
the first end and the second end forming an entry channel extending from the top surface to the bottom surface, wherein the entry channel leads into a central channel within the body; and,
the central channel configured to secure an electrical cord within the body of the cord tangle prevention device.

2. The cord tangle prevention device of claim 1, wherein the single piece of material is a flexible material.

3. The cord tangle prevention device of claim 2, wherein the flexible material enables a user to expand the entry channel allowing the user to securely position the electrical cord within the central channel.

4. The cord tangle prevention device of claim 1, wherein the entry channel extends vertically from the top surface to the bottom surface.

5. The cord tangle prevention device of claim 1, wherein the first end and the second end form a spiral, such that the entry channel spirals into the central channel.

6. The cord tangle prevention device of claim 1, wherein the electrical cord is configured to be clamped within the central channel.

7. The cord tangle prevention device of claim 1, wherein a number of cord tangle prevention devices are configured to be secured along the electrical cord to prevent the electrical cord from tangling.

8. The cord tangle prevention device of claim 7, wherein the body is approximately 6 inches in length.

9. The cord tangle prevention device of claim 2, wherein the flexible material is thermoplastic polyurethane (TPU).

10. The cord tangle prevention device of claim 1, wherein the central channel includes a plurality of channels, wherein each channel of the plurality of channels has a different diameter or width.

11. The cord tangle prevention device of claim 10, further comprising at least one barb positioned between the channels of the plurality of channels, the at least one barb configured to clamp and secure the electrical cord with the central channel.

12. The cord tangle prevention device of claim 1, wherein the entry channel spirals from the top surface to the bottom surface.

13. A cord tangle prevention device comprising:
an elongated body having a top surface and a bottom surface, wherein the elongated body is constructed of a single piece of flexible material having a first end and a second end forming a spiral having a central channel and an entry channel spiraling into the central channel;
the second end approximate to the central channel, and the fist end approximate to entry channel forming a tail of the spiral; and,
the central channel configured to secure and clamp an electrical cord within the elongated body such that the electrical cord does not tangle during use.

14. The cord tangle prevention device of claim 13, wherein the flexible material enabling a user to expand the entry channel allowing the user to securely position and feed the electrical cord within the central channel.

15. The cord tangle prevention device of claim 13, wherein the elongated body is approximately 6 inches in length and a number of the cord tangle prevention devices are configured to be secured along the electrical cord.

16. The cord tangle prevention device of claim 13, wherein the spiral forms between 1 and 2 rotations from the top surface to the bottom surface.
